(19) United States
(12) Patent Application Publication
(10) Pub. No.: US 2009/0037890 A1
(43) Pub. Date: Feb. 5, 2009

(54) METHOD AND SYSTEM FOR GENERATING AN APPLICATION

(75) Inventor: Syed Zafar Kazmi, San Diego, CA (US)

Correspondence Address: SCHWEGMAN, LUNDBERG & WOESSNER, P.A., P.O. BOX 2938, MINNEAPOLIS, MN, 55402, US

(73) Assignee: SmartMicros USA, LLC, San Diego, CA (US)

(21) Appl. No.: 12/184,852

(22) Filed: Aug. 1, 2008

Related U.S. Application Data
(60) Provisional application No. 60/953,865, filed on Aug. 3, 2007.

(51) Int. Cl. G06F 9/45

(52) U.S. Cl. 717/142

(57) ABSTRACT

Methods and systems for generating an application are described. In one embodiment, source code associated with an application may be accessed. A header section of a main segment may be generated based on the compiling. The header section may describe the application. A user interface section of the main segment may be generated based on the compiling. The user interface section may be capable of being used to draw screens, display information, and receive user input. A procedures section of the main segment may be generated based on the compiling. The user interface section may be capable of being used to draw screens, display information, and receive user input. A text resources segment of the application may be generated based on the compiling. The text resources segment may include textual data. A binary resources segment of the application may be generated based on the compiling. The binary resources segment may include binary data.

### CROSS-REFERENCE TO A RELATED APPLICATION

This application claims the benefit of U.S. Provisional Patent Application entitled “A Method and Apparatus for Generating An Application”, Ser. No. 60/953,865, filed 3 Aug. 2007, the entire contents of which are herein incorporated by reference.

### BACKGROUND

There are different ways to define and store an executable application in a binary file. These methods are usually operating system specific and contain executable code for a specific microprocessor. Some specific formats contain non-CPU specific code that requires an interpreter or a virtual machine on the target system for execution. For example a java class file can be executed on any CPU and operating system combination for which Java virtual machine is available. Similarly a BASIC program can be executed on any computer which has BASIC interpreter. The obvious advantage of such programs is their portability across multiple operating systems and processors. Typically, these programs are less efficient and require more resources on the computing system compared to their counterparts designed to run natively on a central processing unit (CPU) and operating system.

### BRIEF DESCRIPTION OF THE DRAWINGS

Some embodiments are illustrated by way of example and not limitation in the figures of the accompanying drawings in which:

FIG. 1 is a block diagram of a system, according to an example embodiment;

FIG. 2 is a block diagram of an example application generation subsystem that may be deployed within the system of FIG. 1 according to an example embodiment;

FIG. 3 is a block diagram of an example application processing subsystem that may be deployed within the system of FIG. 1 according to an example embodiment;

FIG. 4 is a block diagram of an example application that may be deployed within the system of FIG. 1 according to an example embodiment;

FIG. 5 is a block diagram of example items that may be deployed within the application of FIG. 4 according to an example embodiment;

FIG. 6 is a block diagram of an example header that may be deployed within the application of FIG. 4 according to an example embodiment;

FIG. 7 is a block diagram of an example user interface section that may be deployed within the application of FIG. 4 according to an example embodiment;

FIG. 8 is a block diagram of an example visual component that may be deployed within the user interface section of FIG. 7 according to an example embodiment;

FIG. 9 is a block diagram of an example general properties data that may be used within the visual component of FIG. 8 according to an example embodiment;

FIG. 10 is a block diagram of an example menu command data that may be used within the visual component of FIG. 8 according to an example embodiment;

FIG. 11 is a block diagram of an example textedit component that may be deployed within the user interface section of FIG. 7 according to an example embodiment;

FIG. 12 is a block diagram of an example textedit properties data that may be used within the textedit component of FIG. 11 according to an example embodiment;

FIG. 13 is a block diagram of an example textview component that may be deployed within the user interface section of FIG. 7 according to an example embodiment;

FIG. 14 is a block diagram of an example options component that may be deployed within the user interface section of FIG. 7 according to an example embodiment;

FIG. 15 is a block diagram of an example specific properties data that may be used within the options component of FIG. 14 according to an example embodiment;

FIG. 16 is a block diagram of an example additional properties data that may be used within the options component of FIG. 14 according to an example embodiment;

FIG. 17 is a block diagram of an example option item that may be used within the options component of FIG. 14 according to an example embodiment;

FIG. 18 is a block diagram of an example option item that may be used within the options group of FIG. 14 according to an example embodiment;

FIG. 19 is a block diagram of an example procedures section that may be deployed within the application of FIG. 4 according to an example embodiment;

FIG. 20 is a table of actions according to an example embodiment;

FIG. 21 is a table of data types according to an example embodiment;

FIG. 22 is an example representation according to an example embodiment;

FIG. 23 is an example chart according to an example embodiment;

FIG. 24 is an example of other definable data according to an example embodiment;

FIGS. 25 and 26 are example flowcharts illustrating a method for application generation according to example embodiments;

FIG. 27 is an example flowchart illustrating a method for application execution according to an example embodiment;

FIG. 28 is a block diagram of an example application generation subsystem that may be deployed within the system of FIG. 1 according to an example embodiment;

FIG. 29 is an example flowchart illustrating a method for numeric representation according to an example embodiment; and

FIG. 30 is a block diagram diagrammatic representation of machine in the example form of a computer system within which a set of instructions for causing the machine to perform any one or more of the methodologies discussed herein may be executed.

### DETAILED DESCRIPTION

Example methods and systems for generating an application are described. In the following description, for purposes of explanation, numerous specific details are set forth in order to provide a thorough understanding of example embodiments. It will be evident, however, to one skilled in the art that embodiments of the present invention may be practiced without these specific details.

In an example embodiment, source code associated with an application may be accessed. A header section of a main segment may be generated based on the compiling. The header section may describe the application. A user interface section of the main segment may be generated based on the compiling. The user interface section may be capable of being used to draw screens, display information, and receive user input. A procedures section of the main segment may be generated based on the compiling. The user interface section may be capable of being used to draw screens, display information, and receive user input. A text resources segment of the application may be generated based on the compiling. The text resources segment may include textual data. A binary resources segment of the application may be generated based on the compiling. The binary resources segment may include binary data.

In an example embodiment, an occurrence of an event during execution of an application may be determined. A procedure from a procedures section of the application may be identified based on the determining of the occurrence of the event. A plurality of actions associated with the procedure may be loaded based on the identifying of the procedure. Textual data may be accessed from a text resources segment of the application based on a particular action of the plurality of actions. Binary data from a binary resources segment of the application may be accessed based on the particular action. A function of the particular action may be performed based on the instruction specified in the particular action, the textual data, and the binary data. A result of the performing of the function may be provided.

In an example embodiment, a data item of a data type may be received in a textual format. The data type of the data item may be identified as a numeric data type. A number of bytes may be determined for a numeric representation of the data item based on the identifying of the data type. The numeric representation of the data item may be stored.

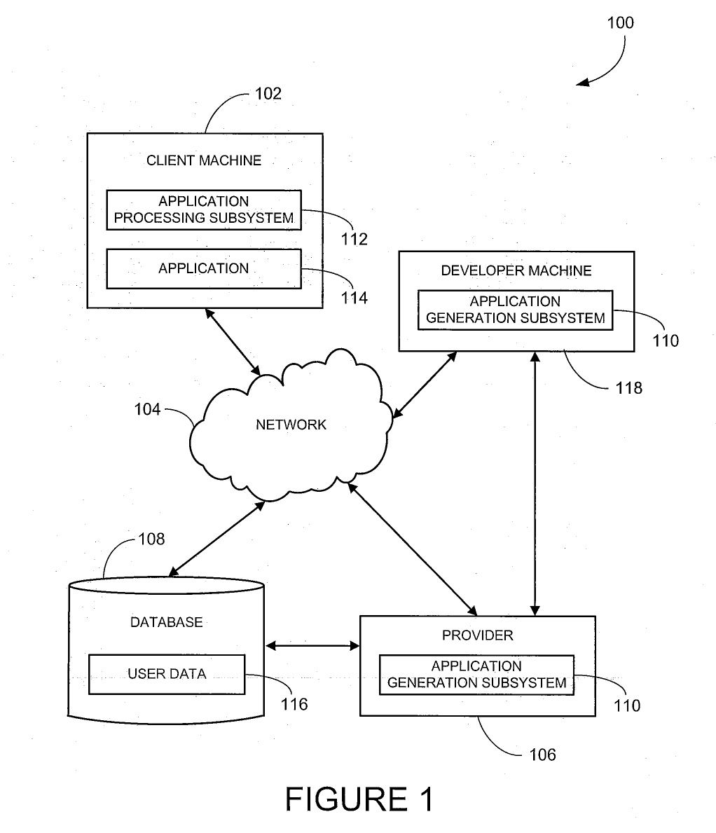

FIG. 1 illustrates an example system 100 in which a client machine 102 may be in communication with a provider 106 over a network 104. A user may operate the client machine 102 to execute an application 114 provided by a provider 106 and/or a developer machine 118 via the network 104 based on a download or other distribution mechanism. Examples of the client machine 102 include a set-top box (STB), a receiver card, a mobile telephone, a personal digital assistant (PDA), a display device, a portable gaming unit, and a computing system; however other devices may also be used.

The network 104 over which the client machine 102 and the provider 106 are in communication may include a Global System for Mobile Communications (GSM) network, CDMA based network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

The provider 106 may send and/or receive data from a user of the client machine. For example, the provider 106 may be a mobile phone carrier, an Internet website, or the like.

An application generation subsystem 110 may be deployed in the provider 106 and/or on the developer machine 118 to generate the application 114. The application generation subsystem may generate the application 114 through compiling formatting language data and/or source programming language. The application may be provided to the client machine 102 from the provider 106 and/or the developer machine 118 after generation. The application 114 may be created by the application generation subsystem 110 in a platform independent manner.

An application processing subsystem 112 may be deployed within the client machine 102 to execute the application 114. The application processing subsystem 112 may be an operating system, an interpreter and/or a virtual machine designed specifically for the client platform that may read and execute the application 114 as configured by the provider 106 or a developer operating the developer machine 118. The application processing subsystem 112 may, in an example embodiment, be implemented as a software module or a built-in component of a client that is designed to run the application 114 on a particular platform.

The application 114 may be operating system and CPU independent. The application 114 may be described in a binary format in a portable, compact, and efficient manner that may be optimized for mobile devices.

The provider 106 may also be in communication with a database 108. The database 108 may include user data regarding the user of the client machine 102. The database 108 may include previously compiled applications 114 to provide to the client machine 102 and/or other devices.

In an example embodiment, a developer writes the application 114 in source code. The developer compiles the source code to create the application 114 on the developer machine 118. The developer then uploads the application 114 to the provider 106. The provider 106 stores the application 114 in the database 108 or otherwise stores the application 114. A user operating the client machine 102 logs into the provider 106. The user then requests download of the application 114. The provider 106 combines a main section of the application 114 along with an appropriate text and binary resources segment based on user's data and packages a final version of the application 114. The provider then sends the application 114 to the client machine 102 for use by the user which is then saved and installed to the client machine 102 by the application processing subsystem 112.

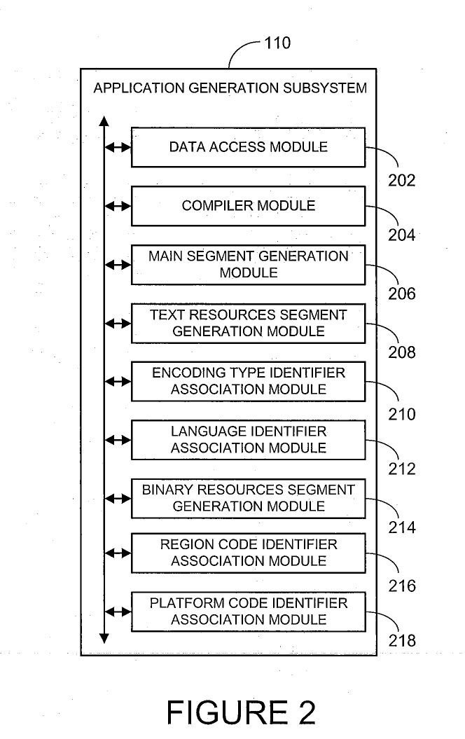

FIG. 2 illustrates an example application generation subsystem 110 that may be deployed in the client machine 102 and/or the provider 106 of the system 100 (see FIG. 1) or otherwise deployed in another system. The application generation subsystem 110 may include a data access module 202, a compiler module 204, a main segment generation module 206, a text resources segment generation module 208, an encoding type identifier association module 210, a language identifier association module 212, a binary resources segment generation module 214, a region code identifier association module 216, and/or a platform code identifier association module 218. Other modules may also be included. The data access module 202 accesses source code associated with the application 114. The compiler module 204 compiles the source code. In an example embodiment, the source code may include formatting language data to control display of information and source programming data. An example of the formatting language data may be as follows:

```
        <?xml version=“1.0” encoding=“ISO-8859-1”?>
<MicroApplication id=“sm.WeatherReport” name=“Weather Report”
    language=“en” MajorVersion=“1” MinorVersion=“0”
    vendor=“SmartMicros” icon=“images/weather.png”>
    <Include>
        <Functions>WeatherReport.sc</Functions>
    </Include>
    <Forms>
        <Form name=“Form” Caption=“Zip Code”>
            <OnExit>GetWeather( )</OnExit>
            <Options name=“day” Caption=“Time” >
                <OptionItem name=“Current” selected=“true” />
                <OptionItem name=“Today” />
                <OptionItem name=“Tomorrow” />
                </Options>>
            <TextEdit name=“zipCode” datatype=“number”
width=“30” caption=“Zip Code”/>
        </Form>
        <Form name=“Result” Caption=“Weather”>
            <TextView name=“data” type=“text” width=“30”
caption=“Report” fullscreen=“true”/>
        </Form>
    </Forms>
</MicroApplication>
        An example of the source programming data may be as follows:
        GetWeather ( ){
send(Form.day, Form.zipCode);
receive(Result.data);
}
```

The main segment generation module 206 generates the main segment of the application 114 based on the compiling. The main segment generation module 206 may generate a header section, a user interface section, and/or a procedures (or code) section of the main segment. The header section may describe the application 114. The user interface section may be capable of being used to draw screens, display information, and receive user input. The main segment generation module may generate a header section of the main segment, the user interface section of the main segment, the procedures section of the main segment, a version identifier for the main segment, a user interface section size identifier for the main segment, and/or a procedures section size identifier for the main segment.

The text resources segment generation module 208 generates a text resources segment of the application 114 based on the compiling. The text resources segment may include textual data and/or an implicit index of the textual data. The textual data may be referenced in the text resources segment by number based on order.

The encoding type identifier association module 210 associates an encoding type identifier with the text resources segment. The language identifier association module 212 associates a language identifier with the text resources segment.

The binary resources segment generation module 214 generates a binary resources segment of the application 114 based on the compiling. The binary resources segment includes binary data and/or an implicit index of the binary data. The generating of the binary resources segment may include generating one or more binary items of the binary resources segment and associating a binary type item identifier with a particular binary item. The binary data may be implicitly indexed in binary resources segment by number based on order. The binary resources segment may include one or more binary objects, one or more multimedia objects, or the like. The binary data and/or the textual data may be defined based on a same data representation scheme. The data representation scheme may enable uniform interpretation and processing of the binary data and the textual data.

In an example embodiment, multiple text and binary resource segments may be created for the application 114. Each text resource segment and binary resource segment may be optimized for a different platform, culture, and/or demographic.

The region code identifier association module 216 associates a region code identifier with the binary resources segment. The platform code identifier association module 218 associates a platform code identifier with the binary resources segment.

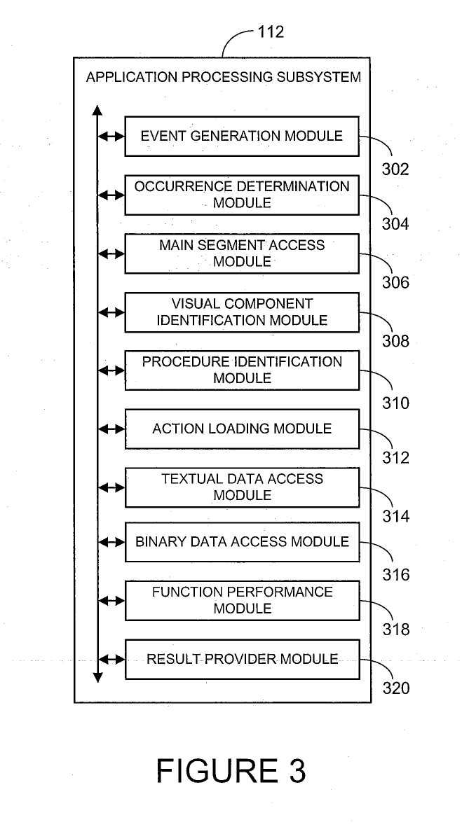

FIG. 3 illustrates an example application processing subsystem 112 that may be deployed in the provider 106 and/or the developer machine 118 of the system 100 (see FIG. 1) or otherwise deployed in another system. The application processing subsystem 112 may include an event generation module 302, an occurrence determination module 304, a main segment access module 306, a visual component identification module 308, a procedure identification module 310, an action loading module 312, a textual data access module 314, a binary data access module 316, a function performance module 318, and/or a result provider module 320. Other modules may also be included.

The event generation module 302 generates the event corresponding to an action of a user of the application 114. The occurrence determination module 304 determines an occurrence of an event during execution of the application 114. The determining of the occurrence may be based on the generation of the event.

The main segment access module 306 accesses a main segment of the application based 114 on the determining of the occurrence. The main segment may include a header section, a user interface section, and/or a procedures section. The procedures section may include a number of action items.

The visual component identification module 308 identifies a visual component based on the determination of the occurrence. A textedit component may be identified as the visual component, a textview component may be identified as the visual component, or a different component may be identified as the visual component.

The procedure identification module 310 identifies a procedure from the procedures section based on the determining of the occurrence of the event. The identification of the procedure may be based on identification of the visual component.

The action loading module 312 loads the actions associated with the procedure based on the identification of the procedure by the procedure identification module. The textual data access module 314 accesses textual data from a text resources segment of the application based on an action.

The binary data access module 316 accesses binary data from a binary resources segment of the application 114 based on the action. The function performance module 318 performs a function of an action based on the instruction specified in an action, the textual data, and/or the binary data.

The result provider module 320 provides a result of the performing of the function by the function performance module. The result of the performing of the function may include displaying textual data with or without special formatting and/or presenting a number of options to the user.

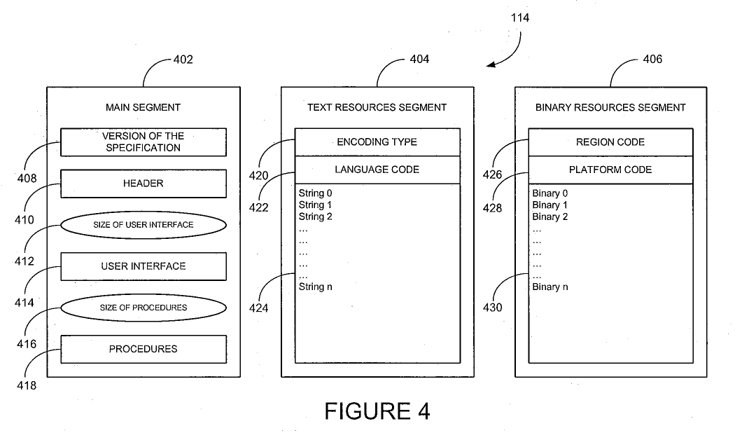

FIG. 4 illustrates an example application 114 according to an example embodiment. The application 114 may be deployed in the client machine 102 of the system 100 (see FIG. 1) or may be deployed otherwise in another system.

The application 114 may include three basic segments including a main segment 402, a text resources segment 404, and/or a binary resources segment 406. The segments 402, 404, 406 may be saved in separate files or may be combined in a single file. The application 114 may include additional segments to enable additional functionality.

The main segment 402 may include a specification version field 408 that includes a byte of data representing a version of the specification that is numeric. The specification may be used (e.g., by the application processing subsystem 112) to determine whether the version of the application 114 is supported by the client machine 102 or is it too old or too new. The specification version field 408 may enable the application generation subsystem 110 to track varying revisions of the application 114 and inform the application processing system 112 of the same. A header section 410 may be included in the main segment 402. The header section 410 may contain basic data to describe the application 114.

A user interface section 414 may be included in the main segment 402. The size of the user interface may be stored in a user interface size field 412 in a 2 or 4 byte numeric representation. However other representations may also be used. The user interface size field 412 may function as a partition between the header section 410 and the user interface section 414.

A procedures section 418 may be included in the main segment 402. The procedures section may include procedures (e.g., code) that is capable of being run by the application 114. The size of the procedures section 418 may be stored in a procedures section size field 416 in a 2 or 4 byte numeric representation. However other representations may also be used. The procedures section size field 416 may function as a partition between the user interface section 414 and the procedures section 418.

The text resources segment 404 may, in an example embodiment contain a list of all of the textual data 424 in the form of strings. The text resources segment 404 may enable the textual data to be separate from the binary data. The separation may enable textual data to be easily substituted to accommodate various languages or cultures.

The first byte in the text resources segment 404 may be an encoding type identifier 420 that indicates the encoding type (e.g. UTF-8, ASCII, ISO-8859-1, etc..). The second byte in the text resources segment 404 may be a language code identifier 422 that identifies the language code (e.g. English, Arabic, Russian, etc.).

The text resources segment 404 may include an implicit index of text strings. Each string within the text resources segment 404 may be indexed by number based on its order. When a particular text item is accessed, an address may be used based on the text item's sequential order within the text resources segment 404.

The binary resources segment 406 may include binary and multimedia objects, e.g. pictures, icons, audio and video clips, that are usable by the application 114. The binary resources segment 406 may be organized in the same manner as the text resources segment 404. Similar to the text resources segment 404, the separation of the binary resources segment 406 from the text resources segment 404 may allow customization of content based on varying languages, cultures, platforms, but it may also be to customize based on the capabilities of the client machine 102 on which the application 114 is executed.

A first byte in the binary resources segment 406 may include a region code identifier 426 that identifies a region code for a target region. The region code identifier 426 may, in an example embodiment, allow distinction based on language and/or culture. A second byte in the binary resources segment 406 may include a platform code identifier 428 that indicates a target platform. The platform code identifier 428 may, in an example embodiment, allow distinction for high resolution, high performance system from more basic systems.

The units of binary data 430 in the binary resources segment 406 may include icon images, audio, video, subprograms, application specific data, or any other binary data. Each binary entry may be stored sequentially in an inherent index. Binary units may be referenced by a numeric address representing their order within the binary resources segment 406. The textual data 424 and/or the binary data 430 may be implicitly indexed.

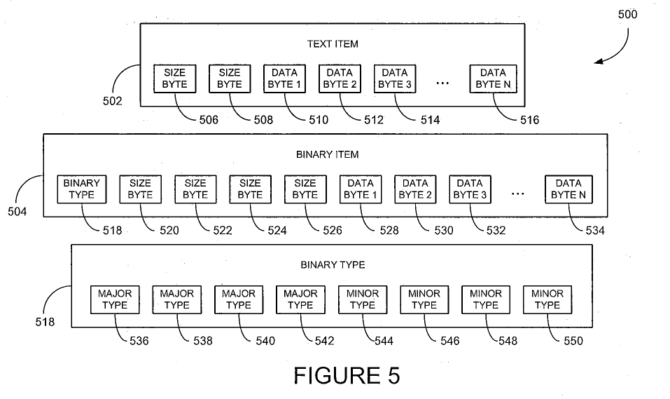

FIG. 5 illustrates example items 500 according to an example embodiment. The items may be deployed in the application 114 of the system 100 (see FIG. 1) or may be otherwise deployed. The example items include a text item 502 and a binary item 504.

The textual data 424 may include one or more text items 502. The text item 502 may be divided in the textual data 424 with delimiters. For example, size bytes 506, 508 may be used to delimit the data bytes 510-516.

The binary data 430 may include one or more binary items 504. The binary item 504 may include a binary type identifier 518 indicating the type of the binary item 504. The binary type identifier 518 may include, in an example embodiment, eight bits 536-550. The top four bits 536-542 may represent a major type of binary item 504. For example, a value of ‘1’ may indicate an image, a value of ‘2’ may indicate audio, etc. The lower four bits 544-550 may indicate a sub-type within the type. For example, a high-order value of ‘1’ may indicate an Image, whereas a low order value of ‘1’ may indicate a PNG image.

Bytes 520-526 may reflect the size of the binary item 504. Bytes 528-534 may include the data of the binary item 504.

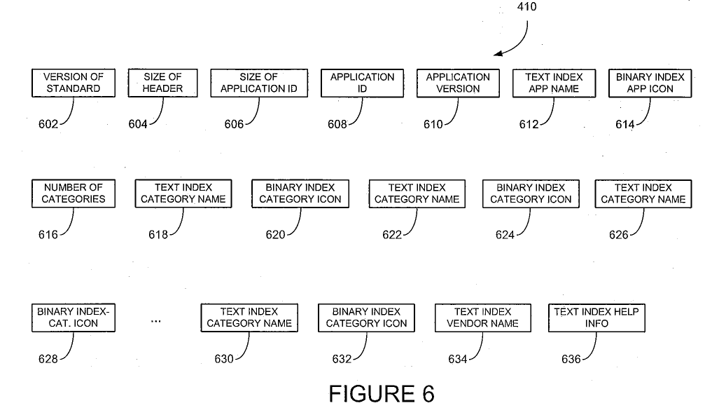

FIG. 6 illustrates an example header section 410 according to an example embodiment. The header section 410 may be deployed in the main segment 402 of the application 114 (see FIG. 4) or may be otherwise deployed.

The header section 410 may contain a series of data 602-636 that describe the application 114. A first byte of the header section 410 a version standard identifier 602 that may include a number representing the version of a standard. The version of standard may inform the client machine 102 how to interpret all other data in the application 114 based on the number of the version standard identifier 602.

A next byte may be header size data 604 including a number representing a size of the header section 410. In an example embodiment, the size of header section 410 stored in the header size data 604 may be a 1 byte number representing the size of the header section 410. The size of header section 410 may include additional bytes to represent larger header sizes.

The header section 410 may include application identifier size data 606 and/or application identifier data 608. The application identifier data 608 may be stored in plain ASCII format with each byte describing one character. The application identifier size data 606 may reflect the size of the application identifier data 608. An application version data 610 may also be stored in the header section 410. The application version data 610 may be a single byte divided into two sets of four bit data. The first four bits may represent the major revision version; and the second four bits may represent the minor revision version. For example, version 12.7 may be represented in binary as: 1100 0111.

Application name data 612 may also be included in the header section 410. The application name data 612 may be a numeric reference to an applicable name string contained in the text resources segment 404. Within the text resource segment 404 at the application reference may be a string that describes the application name. The application name may be different from the application identifier and may be different for different languages and regions while the application identifier may be universal and remain fixed.

The header section 410 may include application icon data 614. The application icon data may use a numeric reference similar to the application name data 612. However, the referenced data may be within the binary resources segment 406. The application icon data 614 may be data of an image associated with the application. 114. If the application 114 does not have an associated icon, the reference value may be zero.

Following application description data 602-614, the header section 410 may include categories or program groups 616-626. The categories or program groups 616-626 be used to group many applications within one category for easy sort and navigation of the application 114 on the client machine 102. The category section may include a category number 616 with a 1 byte number that describes the number of categories. Each category may contain a category name 618 and a category icon 620. The category name 618 may be a numeric reference to the indexed data in the text resources segment 404. The category icon 211 may similarly reference the binary resources segment 406.

Following the categories or program groups 616-626, the header section 410 may include additional data 628-636. The additional data 628-636 may include bytes referencing to include information such as a vendor name 634 or application help information 636. The additional data 628-636 may reference the text resources segment 404 or the binary resources segment 406. Digital signatures, verifying the vendor identity and application integrity, may be included as a part of the additional data 628-636.

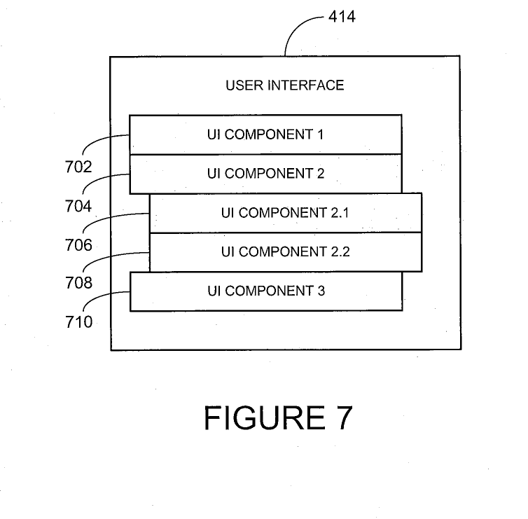

FIG. 7 illustrates an example user interface section 414 according to an example embodiment. The user interface section 414 may be deployed in the main segment 402 of the application 114 (see FIG. 4) or may be otherwise deployed.

The user interface section 414 may include one or more visual components 702-710 of different types to draw screens, display information, and receive user input. Some of the visual components 702-710 maybe a group or collection of other components (e.g., a form component exists as any other component but contains child user interface components). Each visual component 702-710 may exist as a child of a top most visual component.

Each of the visual components 702-710 in the user interface section 414 may be utilized to generate events based on system or user actions related to a particular component. For example, a visual component may be utilized to generate events corresponding to the actions of user that bring the focus to the visual component and make it ready for accepting input from user. The event may be called OnEnter to relate that the visual component is being “entered” into for further interaction. A visual component that may be called an OnInput event may be utilized to generate an event anytime that an Input is received. An OnExit event may be generated when a user decides to navigate away from a visual component. Additional events may be generated by visual components (e.g., an OnInit event may be generated when a visual component is being initialized, an OnClear event may generate when the user tries to clear the data in component, etc.).

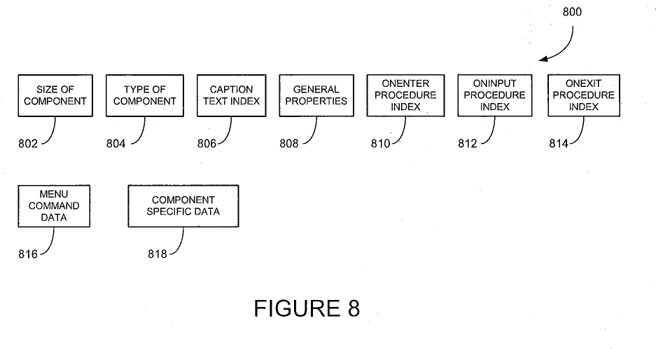

FIG. 8 illustrates an example visual component 800 according to an example embodiment. The visual component 800 may be deployed with the user interface section 414 of the main segment 402 (see FIG. 4) or may be otherwise deployed.

Examples of visual components 800 include a textedit component to gather text input from the user, a textview component to display textual data with or without special formatting (e.g. text styles, special layout, etc.), an options component to present multiple options to the user and receive a use selection, a form component, an image component, or a date and time component. Other visual components 800 may also be deployed with the user interface section 414.

The visual components 800 may share most common and basic attributes and therefore maybe described using same description semantics. For example, the visual component 800 may include component size data 802 that includes the size of the visual component in a numeric representation. The visual component 800 may include component type data 804 and/or caption data 806. The component data 804 may be a numeric data code that represents a general function of the visual component 800. The caption data 806 may refer to an index in the text resources segment 404 that contains a textual name (e.g., caption) of the visual component 800. The general properties data 808 may include general property information regarding the visual component 800.

The event reference data 810, 812, 814 may include a numeric reference to a procedure from the procedures section 418 of the main segment 402. The procedure may be executed by the application 114 when an associated event is triggered.

The menu command data 816 may be included to allow the visual component to inform the application 114 of commands to display when a user invokes a pop-up menu and the actions to be taken if the command is selected.

Component specific data 818 may be included in the visual component 800. The component specific data 818 may be used to include ancillary properties that may be assigned to specific visual components. A number of visual components 800 may be combined together to provide a complete user interface.

In an example embodiment, one or more visual components may be in a hierarchical relationship (e.g., parent-child relationship) with another visual component.

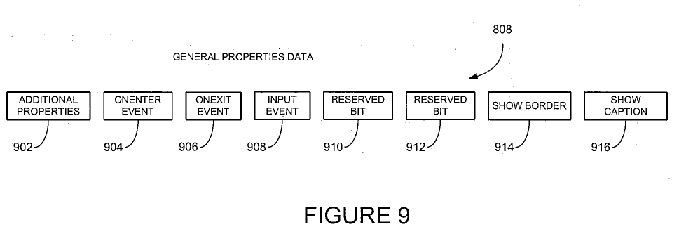

FIG. 9 illustrates an example general properties data 808 according to an example embodiment. The general properties data 808 may be deployed as a portion of the visual component 800 (see FIG. 8) or may be otherwise deployed.

In an example embodiment, the use of the general properties data 808 by all visual components 800 of the application 114 may reduce overhead and improve processing.

The general properties data 808 may include an additional properties indicator 902. The additional properties indicator 902 may be a one bit unit of data that may be interpreted by the application 114 to describe the properties of the visual component 800. The additional properties indicator 902 may be used to indicate presence of subsequent property bytes. For example, the left-most bit 8, if set, may represent the presence of a second property byte.

Event property indicators 904, 906, 908 of the general properties data 808 may indicate the event handlers provided for the particular visual component. The event handlers may be “procedures” that are executed in response to various events (e.g., user input on the client machine 102). The procedures may be defined in the procedures section 418.

The visual component 800 may trigger at least three events, OnEnter, OnExit, and OnInput. If the event handlers are provided for these events, the presence of these may be indicated by the appropriate bit in the event property indicators 904, 906, 908. If the event handler is present, the corresponding bit may be set to 1. If one or more event handlers are provided, the application 114 may interpret the bytes following properties byte(s) as indices to the procedures handling the respective event(s).

The general properties data 808 may include show border bit 914 and/or show caption indicator 916 to control the display attributes of the visual component 800. The show border indicator 914 and/or show caption indicator 916 may be represented as the two right right-most bits of the general properties data 808 or may be otherwise represented. The show caption indicator 916, if set, may indicate to application 114 to display the appropriate caption for the visual component 800. The show border indicator 914 may indicates to the application 114 to draw a border around the visual component. The border may create a visual separation from other visual components. The reserved indicators 910, 912 may include two bits that may be used for other indication purposes as desired (e.g., by an application programmer).

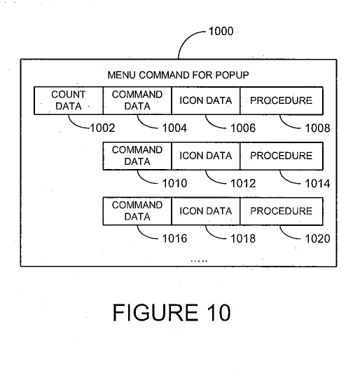

FIG. 10 illustrates example menu command data 816 according to an example embodiment. The menu command data 816 may be used in the visual component 800 (see FIG. 8) or may be used otherwise.

The menu command data 816 may include count data 1002. The count data may include a single byte indicating the number of commands that within the menu command data. A command included in the menu command data 816 may include command name data 1004, 1010, 1016 as a single byte that references a command name in text resources segment 404. The menu command data 816 may include icon data 1006, 1012, 1018 as a single byte that references a graphical icon in the binary resources segment 406. The command may include procedure data 1008, 1014, 1020 that includes a reference to a procedure in the procedures section 418 that may be executed when the option is invoked by the user.

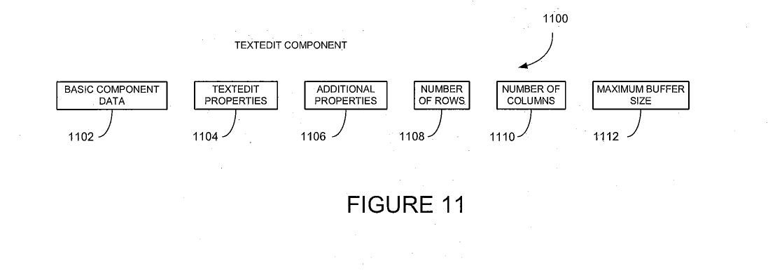

FIG. 11 illustrates an example textedit component 1100 according to an example embodiment. The textexit component 1100 may be deployed with the user interface section 414 of the main segment 402 (see FIG. 4) or may be otherwise deployed.

The textedit component 1100 may include basic component data 1102. The basic component data 1102 may include all or a portion of the data of the visual component 800. Textedit properties data 1104 may be included in the textedit component 1100.

If the application 114 detects no other data after the basis component data 1102, the application 114may assign default values row and column numbers for the client machine 102. If a byte of data exists after the basic component data 1102, the application 114 may determine if number of rows data 1108 specifying a number of rows and number of columns data 1110 specifying a number of columns is present.

A maximum buffer size data 1112 may include a literal numeric representation of the allowable size. If a description of a larger buffer size is used, the application 114 may interpret higher values as multiples of the literal values. For example, the application 114 may multiply values 128 through 196 by a multiple of 2 and values 196-255 by a multiple of 4 to allow the maximum buffer size data 1112 to be interpreted as representing a maximum value of 1024 bytes.

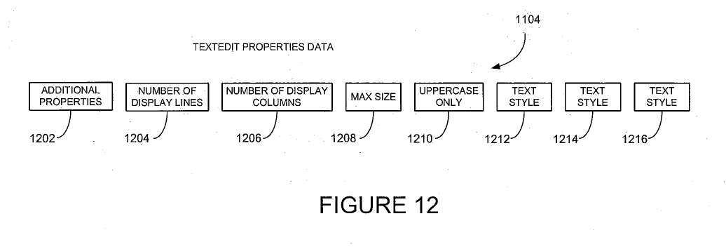

FIG. 12 illustrates an example textedit properties data 1104 according to an example embodiment. The textedit properties data 1104 may be deployed in the textedit component 1100 (see FIG. 11) or may be otherwise deployed.

The textedit properties data 1104 data may have eight bits. The additional properties indicator 1202 may include a top bit value of ‘1’ to indicate the existence of further additional properties. The application 114 may interpret a value of ‘0’ as an indication that the additional properties will be omitted.

A number of display lines indicator 1204 may include a bit that indicates that the number of rows data 1108 representing the number of text display lines will follow the additional properties data 1106.

A number of columns indicator 1110 may include a bit that indicates available number of columns data 1110 on the number of columns. Max size indicator 1208 may include a bit to indicate the existence of the maximum buffer size data 1112 describing the maximum buffer size. The uppercase input indicator 1210 may include a bit that may instruct the application 114 to accept only uppercase input.

Text style data indicators 1212, 1214, 1216 may be used to determine the text style. A text style may be a method by which the application 114 interprets user inputs from the client machine 102 and reformats the data for on-screen presentation. In an example embodiment, the bits 1, 2, and 3 may have values ‘000’, ‘001’, ‘010’, ‘011’, and ‘100’. These values may correspond to the text styles: ‘normal’, ‘decimal’, ‘numeric’, ‘phone’, and ‘email’. The text styles may indicate a presentation style on the client machine 102. In an example embodiment, when a ‘numeric’ text style is indicated, the user interface section 414 may interpret user key presses on a keypad as entry for the numbers 0-9. When an ‘email text style’ is indicated, the user interface may interpret user key presses as letters a-z, numbers 0-9, and symbols ‘@’ and ‘.’. If the number of lines, columns, or buffer size if not specified, the client machine 102 may assign default values to the visual component 800.

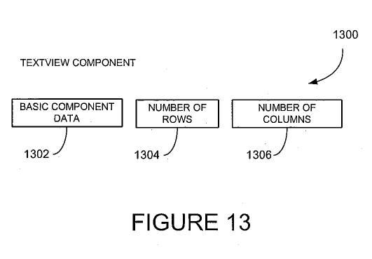

FIG. 13 illustrates an example textview component 1300 according to an example embodiment. The textview component 1300 may be deployed with the user interface section 414 of the main segment 402 (see FIG. 4) or may be otherwise deployed. The textview component 1300 may display textual data with or without special formatting (e.g. text styles, special layout, etc).

The textview component 1300 may include basic component data 1302. The basis component data 1302 may include all or a portion of the data of the visual component 800. The textview component 1300 may include a number of rows data 1304 and/or a number of columns data 1306 that may include data that represents the number of text display lines and the number of columns of the display lines respectively.

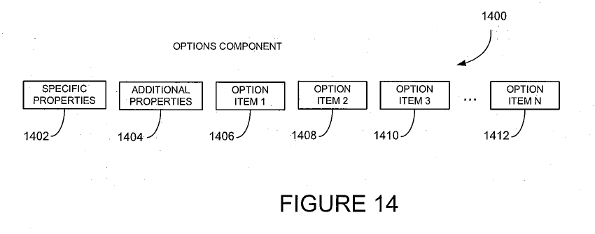

FIG. 14 illustrates an example options component 1400 according to an example embodiment. The options component 1400 may be deployed with the user interface section 414 of the main segment 402 (see FIG. 4) or may be otherwise deployed. The options component 1400 may be used to display multiple options to the user and allow the user to select one or more of the options. The options may be displayed as a list of text items, as icons, or a combination of text and icons.

The options component 1400 may contain a list of option items. An option item may be a singular entity or may be a collection item containing other option items (or collections) as its children. In this hierarchical fashion, the application 114 may make it easier for a user to quickly navigate through a large number of options.

The options component 1400 may include basic component data 1402. The basis component data 1402 may include all or a portion of the data of the visual component 800. The options component 1400 may include specific property data 1402 that includes specific property information of the options component 1400. The options component 1400 may include additional properties data 1404 that includes additional property information of the options component 1400.

Options 1404-1412 may be organized as collections of one or more option groups and/or option items. Option items may be single elements which form the list within any option display. Option groups may be a grouping of other options item and groups which appear as a single item within the options list but may be expanded to display the list of items, or more groups, contained within the group when the options are selected.

The option components 1400 may be organized in a hierarchical fashion and contain other visual components. An example of such a visual component may be a form component. A form component may indicate a logical group of other components which may be displayed together at any given time. A single byte indicating the number of children or sub-components may be included in the component data following all the data associated with the visual component 800. The client machine 102 may use the number of components byte to interpret the following components as included in the group of this component.

Another example of composite component or a component group, maybe a date component. The date component may contain multiple textedit components to accept inputs for month, day, and year separately.

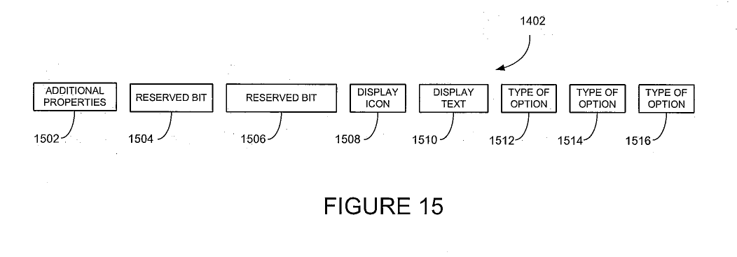

FIG. 15 illustrates an example specific property data 1402 according to an example embodiment. The specific property data 1402 may be included within the options component 1400 of the user interface section 414 or may be used otherwise.

An additional properties indicator may include a bit to act as an indicator of additional properties 1404. For example, a value of ‘1’ may indicate that the next byte following the specific properties data 1402 is the additional properties 1404.

The other indicators in the specific properties data 1402 may indicate the existence of other bytes. Indicators 1512, 1514, 1516 may indicate the type of option. In an example embodiment, the options type may include radios, check boxes, lists, bullets, numbered lists, icon lists, and dropdown menus. Each of these types of options may be assigned a code that may be referenced by the indicators 1512, 1514, 1516.

A display icon indicator 1508 and a display text indicator 1510 may instruct the application 114 to display icon, text or both on screen. The reserved indicators 1504, 1506 may be reserved for later use.

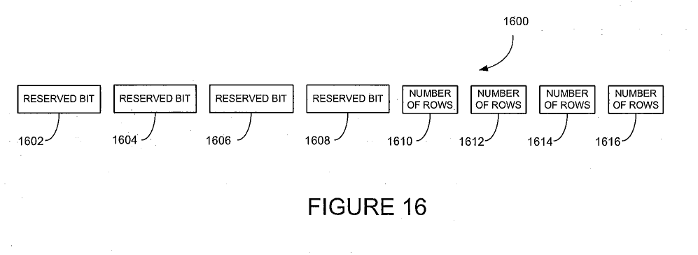

FIG. 16 illustrates an example additional dataproperties data 1404 according to an example embodiment. The additional data properties data 1404 may be included within the options component 1400 of the user interface section 414 or may be used otherwise.

The additional properties data 1404 may include number of rows indicators 1610-1616 that may include data on the number of rows the option will occupy. For example, 4 bits of the additional properties 1404 may be used to indicate up to 16 rows. The reserved indicators 1602-1608 may be reserved for later use.

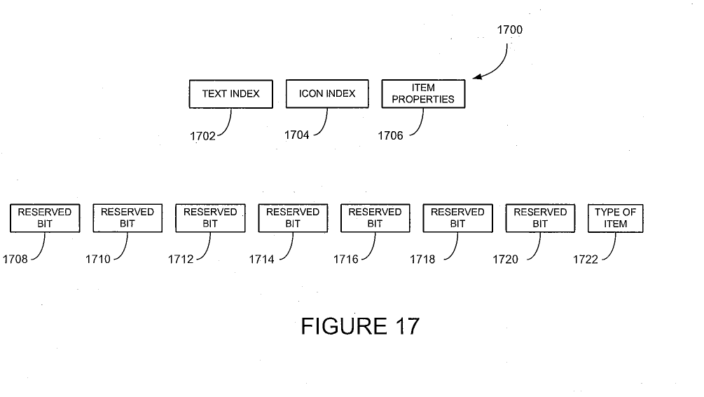

FIG. 17 illustrates an example option item 1700 according to an example embodiment. The option item 1700 may be used in the option component 1400 or may be used otherwise.

The option item 1700 may include text index data 1702, icon index data 1704, and item properties data 1706. The text index data 1702 may be a numeric reference to text describing the item in the text resources segment 404. The icon index data 1704 may be a numeric reference to an icon associated with the item in the binary resources segment 406. The item properties data 1706 may indicate an item type of the option item. For example, a bit value of ‘1’ for a type of item indicator 1722 may indicate a group of items, while a bit value of ‘0’ may indicate a single item. Reserved bits 1708-1720 may be reserved for later use.

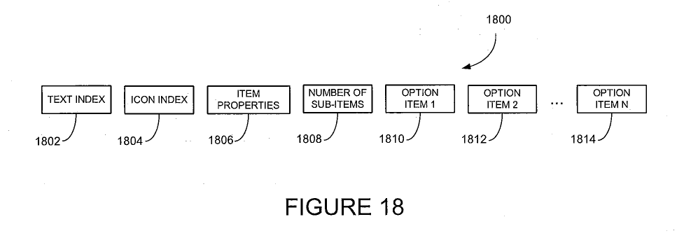

FIG. 18 illustrates an example option group 1800 according to an example embodiment. The option group 1800 may be used in the option component 1400 or may be used otherwise.

The option group 1800 may include text index data 1802, icon index data 1804, and item properties data 1806. The text index data 1802 may be a numeric reference to text describing the item in the text resources segment 404. The icon index data 1804 may be a numeric reference to an icon associated with the item in the binary resources segment 406. The item properties data 1806 may indicate an item type of the option item. In an example embodiment, the existence of additional children components may be indicated in the item properties data 1806. For example, the right-most bit may indicate that the option item is a group and has a child component. If the value of the bit is ‘1’ the application 114 may expect that the next byte will be a number to indicate the number of sub-children in the number of sub-items data 1808. Option items 1810-1814 may also be included in the option group 1800 as sub-children.

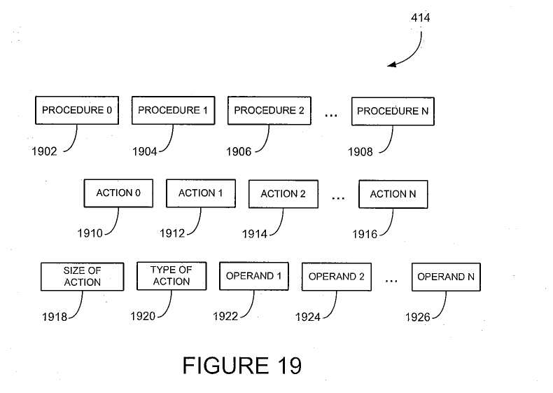

FIG. 19 illustrates an example procedures section 418 according to an example embodiment. The procedures section 418 may be included within the main segment 402 or may be used otherwise.

The procedures section 418 may include multiple procedures 1902-1908 that are series of actions 1910-1916 that may accept input data, operate on the input, and provide a result. An action may represent a low-level instruction to the client machine 102 to operate on input data (operand) or perform a higher level function. A procedure may include a single action or multiple actions.

Actions may appear sequentially in a procedure and may be referenced by an index number based on the order in which they appear. When a procedure is executed, the associated actions may be processed by application 114 in the order that they appear.

Each action may include size of action data 1918 that includes a numeric representation of the size of the action. Each action may include type of action data 1920. Each type of action for the type of action data 1920 may be assigned and represented by a numeric code.

One or more operands 1922-1926 may be included in the action. The operands 1922-1926 may be units of data that may be processed according to the action type. Different actions may use a varying number and types of operands. The manner in which the operands 1922-1926 are processed may also be affected by operand type.

The client machine 102 may begin processing a procedure as a result of some event. The event may be related to a user action, such as those generated by a visual components (e.g. OnInput event), or may be system events based on some timer or other internal or external activities. The client machine 102 may execute the procedure by first loading the procedure, with all its actions, as a list in the memory. The client machine 102 may then start reading each action in sequence and perform appropriate function based on the instruction specified in the action.

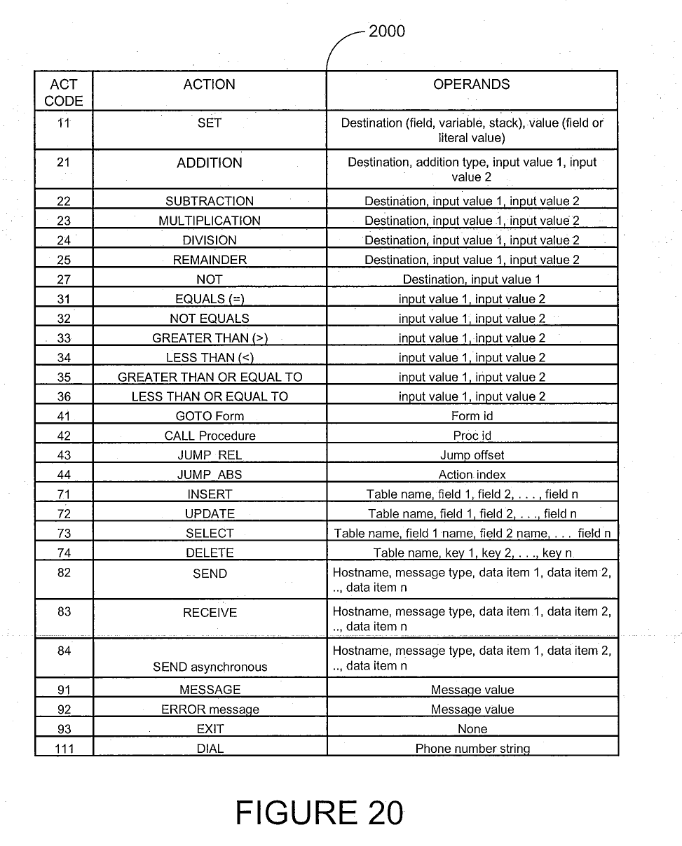

FIG. 20 illustrates an example table of actions 2000 according to an example embodiment. The table of actions 2000 may include a number of values that may be include the type of action data 1920 (see FIG. 19) or may be used otherwise. The table of actions 2000 may enable an action to be performed uniformly regardless of a data type associated with the particular action.

The SET action (11) may assign values or copy data values between fields, variables, and registers. In an example embodiment, the SET action may accept two operands. The first operand may be a destination pointer. The second operand may be a source pointer or a literal value. The action may assign the first operand the value of the second operand.

Action codes for basic arithmetic may also be provided (21-25). In an example embodiment, the ADDITION action (21) may take four operands. The first operand may be the destination reference where the summation result is to be stored. The second operand may specify the type of addition action desired. For example, the type may indicate a text addition, in which case the application 114 may concatenate the values in operand three and four. For example, the ADDITION action may take the operands strings ‘week’ and ‘end’ and produce a resulting string ‘weekend’. Further, depending on the type operand, the ADDITION action may take a date value such as “Feb. 1, 2007” and add 31 days, producing the result “Mar. 4, 2007. Other arithmetic actions may be available such as SUBTRACTION (22), MULTIPLICATION (23), DIVISION (24), and REMAINDER (25), each taking three operands, with the first one being the destination reference and the last two being input values.

Value comparison and Boolean logic operators (27-36) may also be included as a type of action. The operators may accept two operands and return a true or false value based on the type of the action and the input data.

Actions may be included to alter the flow of instructions processing. For example, JUMP_ABS and JUMP_REL actions may specify next action to execute, out of sequence, and CALL may specify a separate procedure for execution.

Actions for data selection and organizations, such as INSERT, UPDATE, SELECT, and DELETE may be included to manipulate the order and insertion of data. Actions to access other parts of the application 114 such as a form may be accessed with the GOTO action.

In an example embodiment, actions for network functions may also be included. Example actions may also include a SEND and RECEIVE actions for data transmission. The SEND (82) and RECEIVE (83) actions may accept operands such as the data to be transmitted, the destination, and protocol. A SEND Asynchronous (84) action may be included to allow application to do data transmission in the background, freeing up the program to act on further actions.

Other actions may include: MESSAGE (91) and ERROR (92), to display messages to the user in a modal or non-modal dialog box. Further actions may be defined to add additional functionality, including actions to control device characteristics, enhanced network communications, and support more features.

Platform specific high level actions may be included to simplify processing. For example a DIAL action on a cell-phone may allow a phone call to be initiated between the device and target number.

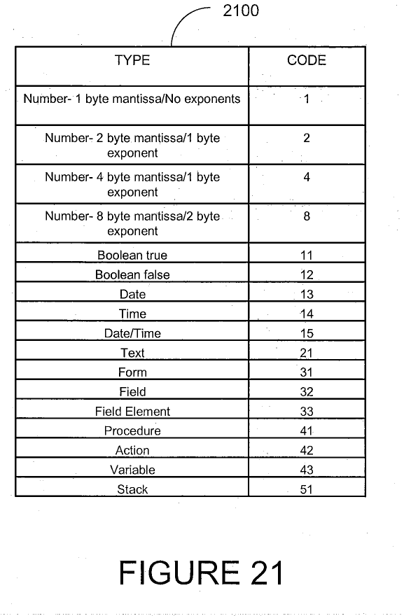

FIG. 21 illustrates an example table of example data types 2100 according to an example embodiment. The table of data types 2100 may be part of a data representation scheme according to an example embodiment. The use of the table of data types 2100 may enable use of multiple numeric representations (e.g., as may be associated with an action).

The data within the application 114 may be defined based on the types 2100. The Defined data may enable interpretation and processing of the data uniformly. In an example embodiment, codes may be assigned to different data types. Codes 1, 2, 4, and 8 may be used to define numeric values in standard form (scientific notation).

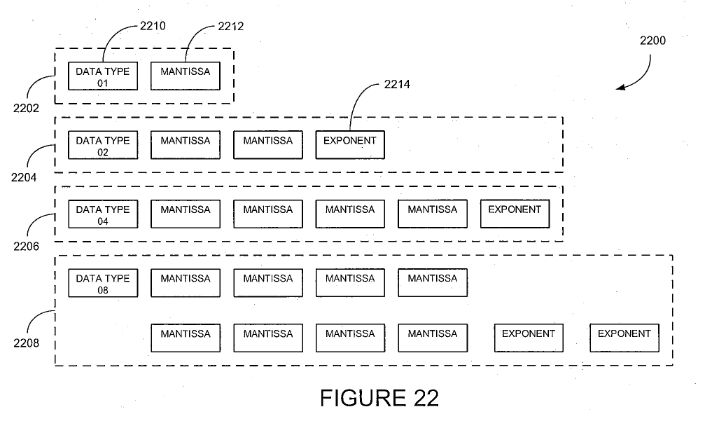

FIG. 22 illustrates an example representation 2200 of numeric data 2202, 2204, 2206, 2208 according to an example embodiment. To define a number, the application 114 may interpret the data depending on size using the numeric data codes. The number may be prefixed with the appropriate numeric data type 2210. Following the data type may be the bytes for a mantissa 2202 and an exponent 2214. For larger numbers, the 2, 4, 8 numeric data types may be available.

Other definable data may include Boolean true and Boolean false which may be assigned data codes 11 and 12 respectively. The Boolean values may not require any other additional data other than data codes itself.

Date and time data may also be defined by using a variation of the Julian calendar date representation. Data codes 13, 14, and 15 may be assigned to date and time data. In an example embodiment, date data may be defined using a hexadecimal number for the year and day of the year. For example, February 1 is the 32^{nd} day of that year and would be represented as 0x20. In addition, the year 2007 may be represented as 0x7d7. The number of characters in the day of year may vary from 1 to three digits depending on the day of the year.

To assist the application 114 in processing of date data, the values 0x100 may be added to the value of date, allowing the day data to constantly remain 3 digits. Time data may be similarly defined. For time data, the number minute of the day (1-1440) may be represented in hexadecimal. An offset value 0x100 may be added to the minute numeric value to always produce a 3 digit hexadecimal number. If time data requires seconds, the time may be represented as the number second of the day (1-86,400) in hexadecimal. The application 114 may add the value of 0x10000 to the second of the day allowing the time value to constantly remain a 5 digit hexadecimal number. The data code 15 may be used by the application 114, when date and time data are required together. In an example embodiment, the date/time unit of data, may begin with the data code 15 and include the hexadecimal number of the day plus 0x100, hexadecimal year and the hexadecimal second of the day plus 0x100000. Text data may defined by the data code 21 followed by a numeric reference to the text resources segment 404.

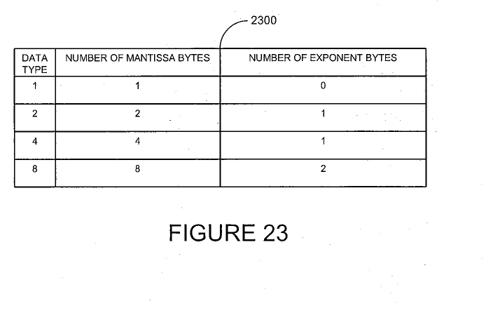

FIG. 23 illustrates an example chart 2300 according to an example embodiment. The chart 2300 may represent values of the numeric data 2202, 2204, 2206, 2208 (see FIG. 22) or may be otherwise used.

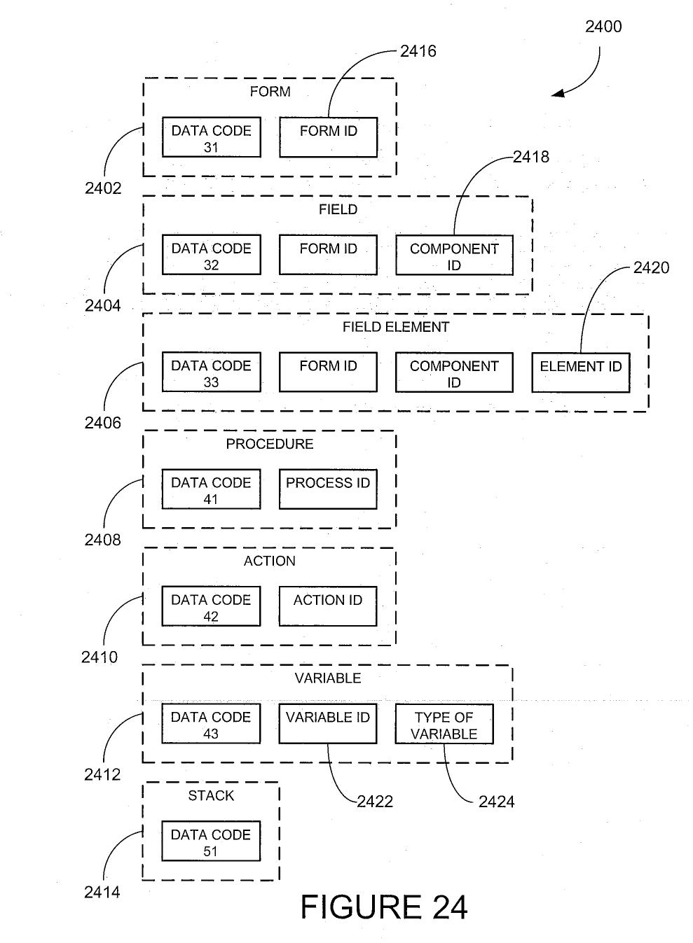

FIG. 24 illustrates an example of other definable data 2400 according to an example embodiment. The additional definable data may include references to forms 2402, fields 2404, field elements 2406, procedures 2408, actions 2410, variables 2412, and stacks 2414. Data that exists in form may be referenced with the data code 31 followed by the form ID 2416. Similarly, a field within a form may be defined as a data code 32 followed by the form ID 2416 and a component ID 2418. An element within a field may be defined as a data code 33 followed by the form ID 2416, the component ID 2418, and an element ID 2420.

Procedures and actions may be referenced with data codes 41 and 42 respectively. Following the data code is the numeric ID associated with the procedure or action. For defining variable data, the definition may include the data code 43, a variable ID 2422, and a type of variable 2424.

For a variable stored within a stack, the definition may include only the data code 51.

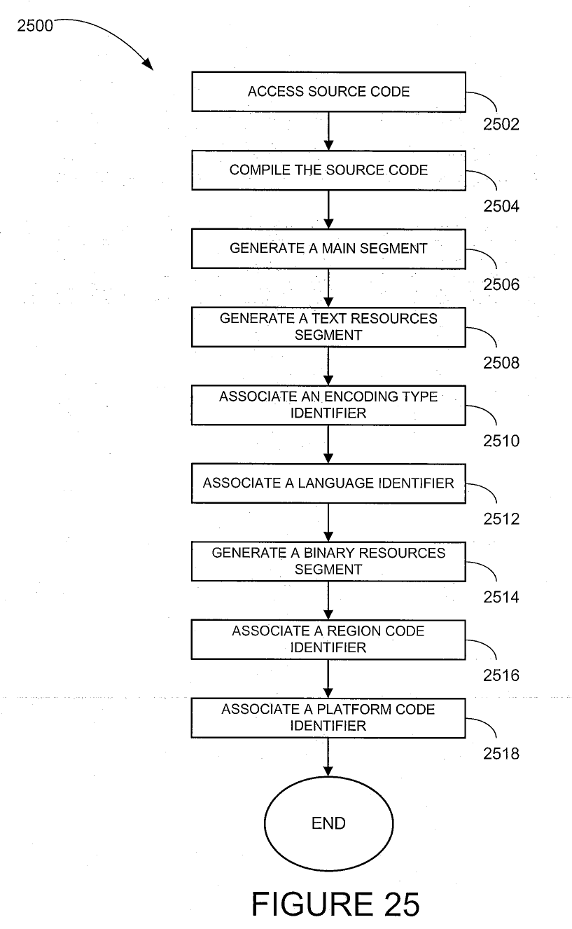

FIG. 25 illustrates a method 2500 for application generation according to an example embodiment. The method 2500 may be performed by the provider 106 and/or the developer machine 118 of the system 100 (see FIG. 1) or otherwise performed.

Source code associated with an application is accessed at block 2502. The source code is compiled at block 2504. For example, the source programming data may be compiled using the formatting language data during the operations at block 2504.

The main segment 402 of the application 114 is generated at block 2506 based on the compiling. The main segment 402 may include the header section 410, the user interface section 414, and/or the procedures section 418. The header section 410 may describe the application 114. The user interface section 414 may be capable of being used to draw screens, display information, and receive user input.

The text resources segment 404 of the application 114 is generated at block 2508 based on the compiling. The text resources segment 404 may include the textual data 424 and/or an index of the textual data 424. The textual data 424 may be referenced in the text resources segment 404 by number based on order.

An encoding type identifier may be associated with the text resources segment 404 at block 2510. A language identifier may be associated with the text resources segment 404 at block 2512.

The binary resources segment 406 of the application 114 is generated at block 2514 based on the compiling. The binary resources segment 406 may include the binary data 430 and/or an index of the binary data 430. The binary data 430 may be indexed in the binary resources segment 406 by number based on order. The binary resources segment 406 may include one or more binary object, one or more multimedia objects, or the like.

In an example embodiment, the generation of the binary resources segment 406 may include generating one or more binary items of the binary resources segment 406 and associating a binary type item identifier with a particular binary item.

In an example embodiment, the binary data 430 and the textual data 424 may be defined based on a data representation scheme. The data representation scheme may enable uniform interpretation and processing of the binary data 430 and the textual data 424.

A region code identifier may be associated with the binary resources segment 406 at block 2516. A platform code identifier may be associated with the binary resources segment 406 at block 2518.

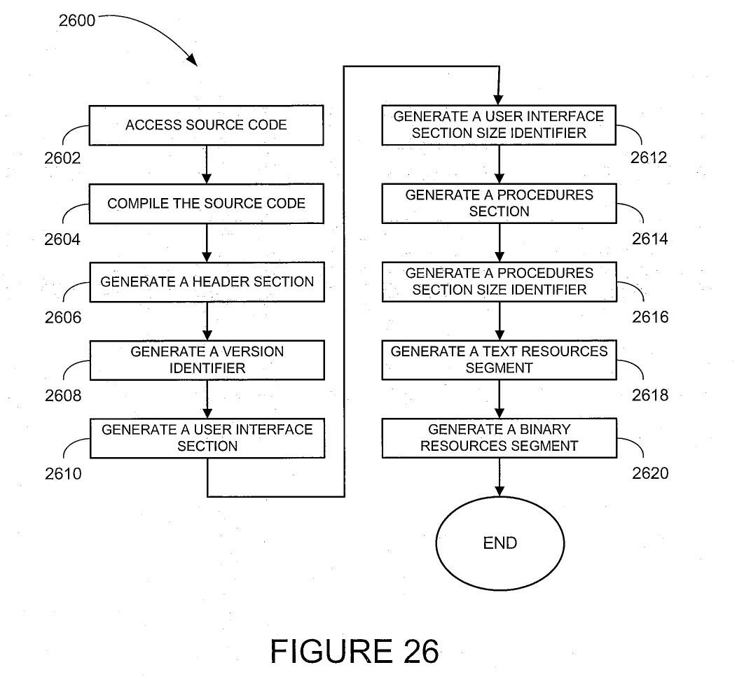

FIG. 26 illustrates a method 2600 for application generation according to an example embodiment. The method 2600 may be performed by the provider 106 and/or the developer machine 118 of the system 100 (see FIG. 1) or otherwise performed.

Source code associated with an application is accessed at block 2602. The source code is compiled at block 2604. For example, the source programming data may be compiled using the formatting language data during the operations at block 2604.

The header section 410 of the main segment 402 is generated at block 2606 based on the compiling. The header section 410 may describe the application 114.

A version identifier may be generated for the main segment 402 based on the compiling at block 2608. The version identifier may be capable of being used to track revisions to the application 114.

The user interface section 414 of the main segment 402 is generated based on the compiling at block 2610. The user interface section 414 may be capable of being used to draw screens, display information, and receive user input.

The generation of the user interface section 414 may include generating visual components of the user interface section 414. The visual components may be organized in a hierarchical manner or organized otherwise. A visual component of the user interface section may be capable of being utilized to generate an event corresponding to an action of a user of the application. The events may include, by way of example an OnEnter event, an OnInput event, an OnExit event, an OnInit event, an OnClear event, or the like.

The visual component may include a component size field, a component type field, a component caption field, a general proprieties field, an event field, a popup menu command field, and/or a component specific data field. Other fields may also be included.

The visual components may include a textedit component, a textview component, an options component, a form component, an image component, a date and time component, or the like.

The textview component may be configured to display textual data with or without special formatting. The textview component may include, by way of example, a number of rows field and/or a number of columns field. Other fields may also be included.

The textedit component may be configured to gather text as the user input. The textedit component may include a textedit properties field, a number of rows field, a number of columns field, and/or a maximum buffer size field. Other fields may also be included.

The options component may be configured to present a number of options to the user and receive a particular selection of an option. The options component may include, by way of example, a specific properties field, an additional properties field, an options group, and/or an options item. Other fields may also be included.

A user interface section size identifier may be generated for the main segment 402 at block 2612 based on the compiling and/or the generation of the user interface section 414.

The procedures section 418 of the main segment 402 is generated at block 2614. The generation of the procedures section 418 may include generating procedures for the procedures section 418. A procedure may be capable of accessing input data, processing the input data, and/or providing a result based on the processing of the input data.

A procedure may include a number of actions. An action may represent a low-level machine instruction. The actions may be in a sequential order for a procedure and/or may be capable of being referenced by an index number based of the sequential order. An action may include a size of action field, a type of action field, and/or an operands field. Other fields may also be included.

The actions may include, by way of example, a set action, an addition action, a subtraction action, a multiplication action, a division action, a remainder action, a not action, an equals action, a not equals action, a greater than action, a less than action, a greater than or equal to action, a less than or equal to action, a goto form action, a call procedure action, a relative jump action, an absolute jump action, an insert action, an update action, a select action, a delete action, a send action, a receiver action, a send asynchronous action, a message action, an error message action, an exit action, a dial action, or the like. Other actions may also be included.

A procedures section size identifier may be generated for the main segment 402 at block 2616 based on the compiling and/or the generation of the procedures section 418.

The text resources segment 404 of the application 114 is generated at block 2618 based on the compiling. The text resources segment 404 may include the textual data 424 and/or an index of the textual data 424. The textual data 424 may be referenced in the text resources segment 404 by number based on order.

The binary resources segment 406 of the application 114 is generated at block 2620 based on the compiling. The binary resources segment 406 may include the binary data 430 and/or an index of the binary data 430. The binary data 430 may be indexed in the binary resources segment 406 by number based on order.

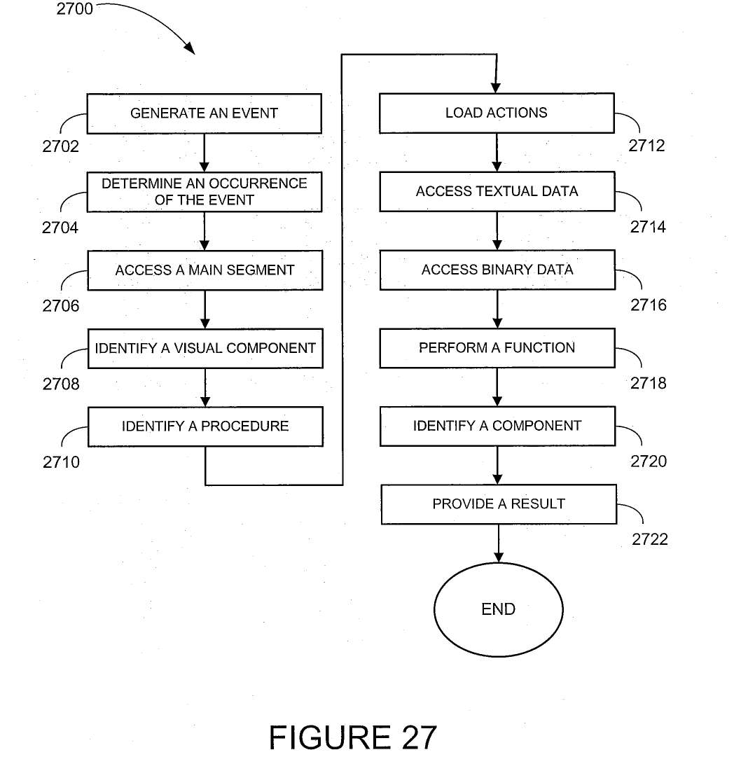

FIG. 27 illustrates a method 2700 for application execution according to an example embodiment. The method 2700 may be performed by the client machine 102 and/or the provider 106 of the system 100 (see FIG. 1) or otherwise performed.

An event corresponding to an action of a user of the application 114 may be generated at block 2702. The actions may include a set action, an addition action, a subtraction action, a multiplication action, a division action, a remainder action, a not action, an equals action, a not equals action, a greater than action, a less than action, a greater than or equal to action, a less than or equal to action, a goto form action, a call procedure action, a relative jump action, an absolute jump action, an insert action, an update action, a select action, a delete action, a send action, a receiver action, a send asynchronous action, a message action, an error message action, an exit action, a dial action, or the like.

At block 2704, an occurrence of an event is determined during execution of an application 114. The determination of the occurrence may be based on the generation of the event. The event may be associated with a user action, a system event, or the like. The event may be, by way of example, an OnEnter event, an OnInput event, an OnExit event, an OnInit event, or an OnClear event.

The main segment 402 of the application 114 may be accessed at block 2706 based on the determining of the occurrence. The main segment 402 may include the header section 410, the user interface section 414, and/or the procedures section 418. The procedures section 418 may include a number of action items.

A visual component may be identified at block 2708 based on the determination of the occurrence. A procedure from the procedures section 418 is identified at block 2710 based on the determining of the occurrence of the event. The identification of the procedure may be based on identification of the visual component.

The actions associated with the procedure are loaded at block 2712 based on identification of the procedure. At block 2714, the textual data 424 is accessed from the text resources segment 404 of the application 114 based on one or more actions.

At block 2716, the binary data 430 is accessed from the binary resources segment 406 of the application 114 based on the action. A function of the action is performed at block 2718 based on the instruction specified in the action, the textual data 424, and/or the binary data 430. A textedit component and/or a textview component may be identified as the visual component at block 2720.

A result of the performance of the function is provided at block 2722. The result may include displaying textual data with or without special formatting, presenting a number of options to the user, or the like. The result may be provided to a user of the client machine 102 by displaying a new screen or updating the contents of an existing screen.

In an example embodiment, the methods and systems above may provide for increased platform independence while not utilizing significantly more memory and storage resources.

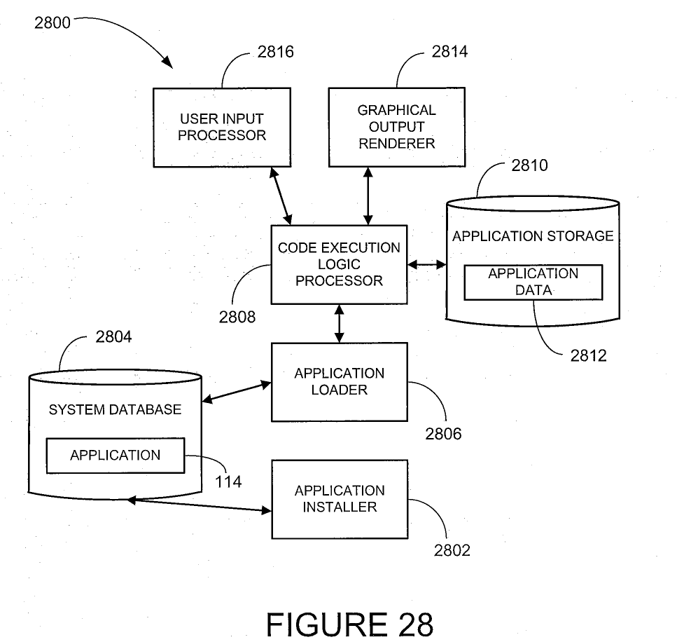

FIG. 28 illustrates an example application generation subsystem 110 that may be deployed in the client machine 102 and/or the provider 106 of the system 100 (see FIG. 1) or otherwise deployed in another system.

An application installer 2802 installs the application 114 on the client machine 102 and/or stores the application 114 into a system database 2804. The application installer 2802 may verify the application 114, check for prior versions of the application 114, and/or determine compatibility of the application 114. The application 114 may be accessed locally (e.g., from digital media) or remotely (e.g., over a network 104) by the application installer 2802 for installation.

The application loader 2806 loads the application 114 for use (e.g., from the system database 2804). The application loader 2806 may load the application 114 into memory and/or convert the application 1143 into a representation that is executable.

A code execution logic processor 2808 may store and read application data 2812 in an application storage 2810. The application data 2812 may include data, files, configurations, or the like. The code execution logic processor 2808 may receive input from a user input processor 2816 and provide an output through a graphical output renderer 2814. The code execution logic processor 2808 may process the procedures of the procedures section 418, while the visual components 800 of the user interface section 800 may be processed by the graphical output renderer 2814.

The code execution logic processor 2808 may include the functionality of the occurrence determination module 304, the main segment access module 306, the procedure identification module 310, the action loading module 312, the textual data access module 314, the binary data access module 316, the function performance module 318, and/or the result provider module. The graphical output renderer 2814 may include the functionality of the main segment access module 306, visual component identification module 308, the textual data access module 314, the binary data access module 316, and/or the result provider module 320.

The user input processor 2816 may generate an event based on user input. The user input processor 2816 may include the functionality of the event generation module 302 (see FIG. 3).

By way of an example, when a user clicks on a key or presses a button on the client machine 102, an event may be triggered by the user input processor 2816. The code execution logic processor 2808 may receive and respond to a code from the user input processor 2816. A procedure may be executed by the code execution logic processor 2808 based on the receiving of the code.

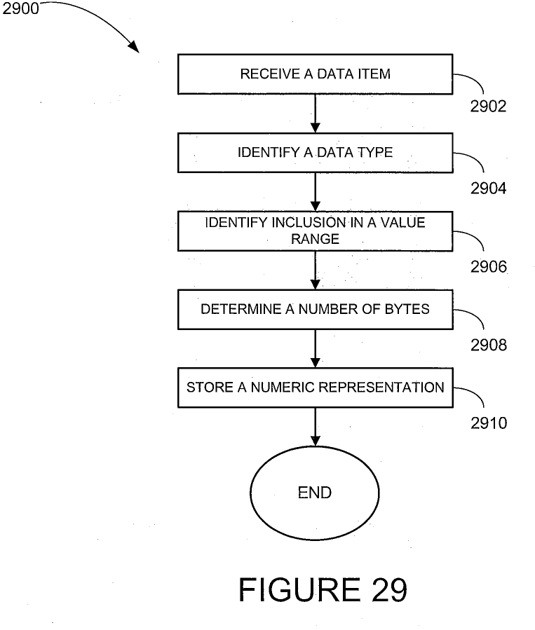

FIG. 29 illustrates a method 2900 for numeric representation according to an example embodiment. The method 2900 may be performed by the provider 106 and/or the developer machine 118 of the system 100 (see FIG. 1) or otherwise performed.

A data item of a data type is received in a textual format at block 2902. The data type of the data item is identified as a numeric data type at block 2904. Inclusion of the data item in a value range of available value ranges may be identified at block 2906.

A number of bytes for a numeric representation of the data item are determined at block 2908 based on identification of the data type. The determining of the number of bytes may be based on identification of the inclusion. The numeric representation of the data item is stored at block 2910.

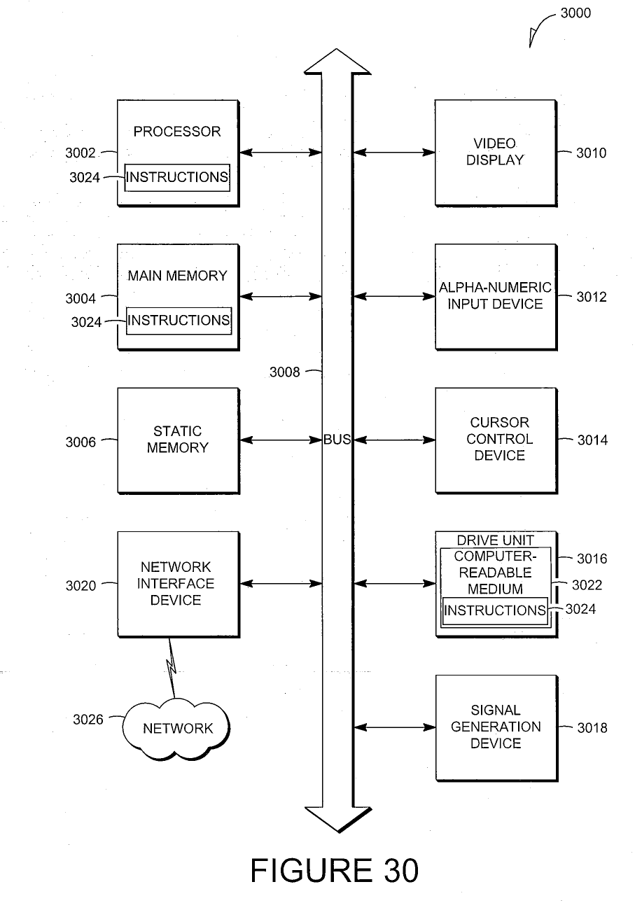

FIG. 30 shows a diagrammatic representation of machine in the example form of a computer system 3000 within which a set of instructions may be executed causing the machine to perform any one or more of the methods, processes, operations, or methodologies discussed herein. The provider 106 and/or the developer machine 118 may operate on or more computer systems 3000. The client machine 102 may include the functionality of one or more computer systems 3000.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 3000 includes a processor 3002 (e.g., a central processing unit (CPU) a graphics processing unit (GPU) or both), a main memory 3004 and a static memory 3006, which communicate with each other via a bus 3008. The computer system 3000 may further include a video display unit 3010 (e.g., a liquid crystal display (LCD) or a cathode ray tube (CRT)). The computer system 3000 also includes an alphanumeric input device 3012 (e.g., a keyboard), a cursor control device 3014 (e.g., a mouse), a drive unit 3016, a signal generation device 3018 (e.g., a speaker) and a network interface device 3020.

The drive unit 3016 includes a machine-readable medium 3022 on which is stored one or more sets of instructions (e.g., software 3024) embodying any one or more of the methodologies or functions described herein. The software 3024 may also reside, completely or at least partially, within the main memory 3004 and/or within the processor 3002 during execution thereof by the computer system 3000, the main memory 3004 and the processor 3002 also constituting machine-readable media.

The software 3024 may further be transmitted or received over a network 3026 via the network interface device 3020.

While the machine-readable medium 3022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the embodiments of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for generating an application have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing source code associated with an application;
compiling the source code;
generating a header section of a main segment based on the compiling, the header section describing the application;
generating a user interface section of the main segment based on the compiling, the user interface section capable of being used to draw screens, display information, and receive user input;
generating a procedures section of the main segment based on the compiling;
generating a text resources segment of the application based on the compiling, the text resources segment including textual data; and
generating a binary resources segment of the application based on the compiling, the binary resources segment including binary data.

2. The method of claim 1, wherein the generating the user interface section comprises:
generating a plurality of visual components of the user interface section, a particular visual component capable of being utilized to generate an event corresponding to an action of a user of the application.

3. The method of claim 2, wherein a particular visual component of the plurality of visual components may be in a hierarchical relationship with another visual component of the plurality of visual components.

4. The method of claim 3, wherein the plurality of visual components include the basic component data and a particular visual component of the visual components includes additional data beyond the basic component data.

5. The method of claim 2, wherein the event includes an OnEnter event, an OnInput event, an OnExit event, an OnInit event, or an OnClear event.

6. The method of claim 2, wherein the particular visual component includes at least one of a component size field, a component type field, a component caption field, a general proprieties field, an event field, a popup menu command field, a component specific data field, or combinations thereof.

7. The method of claim 2, wherein the plurality of visual components include a textedit component, a textview component, an options component, a form component, an image component, a date and time component, or combinations thereof,
wherein the textview component is configured to display textual data with or without special formatting, the textedit component is configured to gather text as the user input, and the options component is configured to present a plurality of options to the user and receive a particular selection of the plurality of options.

8. The method of claim 7, wherein the options component includes a specific properties field, an additional properties field, an options group, an options item, or combinations thereof,
wherein the options group includes a grouping of a plurality of options items that may be expanded to display the grouping when the options grouping is selected.

9. The method of claim 8, wherein the grouping of the plurality of options items includes an additional options group.

10. The method of claim 2, wherein the plurality of visual components are organized in a hierarchical manner.

11. The method of claim 1, wherein the generating the procedures section comprises:
generating a plurality of procedures for the procedures section, a particular procedure of the plurality of procedures being capable of accessing input data, processing the input data, and providing a result based on the processing of the input data.

12. The method of claim 11, wherein the particular procedure includes a plurality of actions, a particular action of the plurality of actions representing a low-level machine instruction.

13. The method of claim 12, wherein the plurality of actions are in a sequential order for the particular procedure and are capable of being referenced by an index number based of the sequential order.

14. The method of claim 12, wherein the plurality of actions include a set action, an addition action, a subtraction action, a multiplication action, a division action, a remainder action, a not action, an equals action, a not equals action, a greater than action, a less than action, a greater than or equal to action, a less than or equal to action, a goto form action, a call procedure action, a relative jump action, an absolute jump action, an insert action, an update action, a select action, a delete action, a send action, a receiver action, a send asynchronous action, a message action, an error message action, an exit action, a dial action, or combinations thereof.

15. The method of claim 1, wherein the header section includes at least one of a standard version field, a header size field, an application size field, an application identifier field, an application version field, an application name field, an application icon field, a number of categories field, a category name field, a category icon field, an additional data field, or combinations thereof.

16. The method of claim 1, wherein the textual data is referenced in the text resources segment by number based on order.

17. The method of claim 1, wherein the binary data is implicitly indexed in binary resources segment by number based on order.

18. The method of claim 1, wherein the binary data and the textual data are defined based on a data representation scheme, the data representation scheme including a numeric representation of numbers using a variable number of bytes.

19. A method comprising:
determining an occurrence of an event during execution of an application;
identifying a procedure from a procedures section of an application based on the determining of the occurrence of the event;
loading a plurality of actions associated with the procedure based on the identifying of the procedure;
accessing textual data from a text resources segment of the application based on a particular action of the plurality of actions;
accessing binary data from a binary resources segment of the application based on the particular action;
performing a function of the particular action based on the instruction specified in the particular action, the textual data, and the binary data; and
proving a result of the performing of the function.

20. The method of claim 19, further comprising:
accessing a main segment of the application based on the determining of the occurrence, the main segment including a header section, a user interface section, and a procedures section, the procedures section including the plurality of action items;

21. The method of claim 19, further comprising:
generating the event corresponding to an action of a user of the application, wherein the determining of the occurrence is based on the generating of the event.

22. The method of claim 19, wherein the event includes an OnEnter event, an OnInput event, an OnExit event, an OnInit event, or an OnClear event.

23. The method of claim 19, further comprising:
identifying a visual component based on the determining of the occurrence,
wherein the identifying of the procedure is based on the identifying of the visual component.

24. The method of claim 23, wherein the identifying the visual component comprises:
identifying a textedit component as the visual component,
wherein the result of the performing of the function includes displaying textual data with or without special formatting.

25. The method of claim 23, wherein the identifying the visual component comprises:
identifying a textview component as the visual component,
wherein the result of the performing of the function includes presenting a plurality of options to the user.

26. The method of claim 19, wherein the event is associated with a user action, a system event, or combinations thereof.

27. The method of claim 19, wherein a particular action of the plurality of actions may be performed uniformly regardless of a data type associated with the particular action.
loading a plurality of actions associated with the procedure based on the identifying of the procedure;

28. The method of claim 27, wherein the plurality of numeric representations associated with the particular action may be represented differently.

29. A method comprising:
receiving a data item of a data type in a textual format;
identifying the data type of the data item as a numeric data type;
determining a number of bytes for a numeric representation of the data item based on the identifying of the data type; and
storing the numeric representation of the data item.

30. The method of claim 29, further comprising:
identifying inclusion of the data item in a value range of a plurality of available value ranges,
wherein the determining of the number of bytes is based on the identifying of the inclusion.

31. A machine-readable medium comprising instructions, which when implemented by one or more processors perform the following operations:
access source code associated with an application;
compile the source code;
generating a header section of a main segment based on the compiling, the header section describing the application;
generating a user interface section of the main segment based on the compiling, the user interface section capable of being used to draw screens, display information, and receive user input;
generating a procedures section of the main segment based on the compiling;
generate a text resources segment of the application based on the compilation, the text resources segment including textual data; and
generate a binary resources segment of the application based on the compilation, the binary resources segment including binary data.

32. The machine-readable medium of claim 31, wherein the binary data and the textual data are defined based on a data representation scheme, the data representation scheme enabling uniform interpretation and processing of the binary data and the textual data.

33. A machine-readable medium comprising instructions, which when implemented by one or more processors perform the following operations:
determine an occurrence of an event during execution of an application;
identify a procedure from a procedures section of the application based on the determination of the occurrence of the event;
load a plurality of actions associated with the procedure based on identification of the procedure;
access textual data from a text resources segment of the application based on a particular action of the plurality of actions;
access binary data from a binary resources segment of the application based on the particular action;
perform a function of the particular action based on the instruction specified in the particular action, the textual data, and the binary data; and
prove a result of performance of the function.

34. The machine-readable medium of claim 33, wherein the plurality of actions include a set action, an addition action, a subtraction action, a multiplication action, a division action, a remainder action, a not action, an equals action, a not equals action, a greater than action, a less than action, a greater than or equal to action, a less than or equal to action, a goto form action, a call procedure action, a relative jump action, an absolute jump action, an insert action, an update action, a select action, a delete action, a send action, a receiver action, a send asynchronous action, a message action, an error message action, an exit action, a dial action, or combinations thereof.

35. A system comprising:
a processor;
a data access module coupled to the processor to access source code associated with an application;
a compiler module to compile the source code;
a main segment generation module to generate a main segment of an application based on the compiling by the compiler module, the main segment including a header section, a user interface section, and a procedures section, the header section describing the application, the user interface section capable of being used to draw screens, display information, and receive user input;
a text resources segment generation module to generate a text resources segment of the application based on the compiling by the compiler module, the text resources segment including textual data; and
a binary resources segment generation module to generate a binary resources segment of the application based on the compiling by the compiler module, the binary resources segment including binary data.

36. The system of claim 35, further comprising:
an occurrence determination module to determine an occurrence of an event during execution of the application;
a procedure identification module to identify a procedure from the procedures section based on the determining of the occurrence of the event by the occurrence determination module;
an action loading module to load the plurality of actions associated with the procedure based on the identifying of the procedure by the procedure identification module;
a textual data access module to access textual data from the text resources segment generated by the text resources segment generation module based on a particular action of the plurality of actions;
a binary data access module to access binary data from the binary resources segment generated by the binary resources segment generation module based on the particular action;
a function performance module to perform a function of the particular action based on the instruction specified in the particular action, the textual data, and the binary data; and
a result provider module to prove a result of the performing of the function by the function performance module.
